(19) United States
(12) Patent Application Publication
(10) Pub. No.: US 2024/0426170 A1
(43) Pub. Date: Dec. 26, 2024

(54) OVERHEAD DOOR APPARATUS

(71) Applicants: Rene Charbonneau, Dalroy (CA); Diane Le Bouthillier, Dalroy (CA)

(72) Inventors: Rene Charbonneau, Dalroy (CA); Diane Le Bouthillier, Dalroy (CA)

(21) Appl. No.: 18/825,131

(22) Filed: Sep. 5, 2024

Related U.S. Application Data
(63) Continuation-in-part of application No. 17/655,303, filed on Mar. 17, 2022.

(51) Int. Cl. E06B 7/23

(52) U.S. Cl. CPC E06B 7/2316

(57) ABSTRACT

An overhead door apparatus that is configured to be placed across an opening of a structure wherein the invention will be adjacent the bottom edge of an overhead door secured to the opening when the overhead door is in a closed position. The invention includes a body that is elongated in shape being comprised of a first segment, a second segment and a third segment being contiguously formed. The second segment includes a first portion and a second portion that are angular in orientation with respect to each other having a rounded top edge at a transition point therebetween. Contiguously formed with the body are wing members wherein the wing members extend outward from the body and are configured to have a fastener journaled therethrough. A sealing member is secured to the bottom of the body and extends along the length thereof proximate a longitudinal edge of the third segment.

### CROSS REFERENCE TO RELATED APPLICATIONS

This non-provisional application is a continuation in part of U.S. patent application Ser. No. 17/655,303 filed Mar. 17, 2022, entitled, Overhead Door Apparatus, which is hereby incorporated for reference

### FIELD OF THE INVENTION

The present invention relates generally to overhead door and accessories thereof, more specifically but not by way of limitation, any door apparatus that is positioned on the ground so as to be adjacent the bottom edge of the various types of doors such as but not limited to side doors, bi-fold doors, overhead doors and other door types on the exterior of buildings, when the door is in its closed position, wherein the present invention prevents freezing of the overhead door to the ground.

### BACKGROUND

As is known in the art, overhead doors are commonly utilized for garages and shops where large items and vehicles need access to enter and exit the opening of the structure. Conventional overhead doors will consist of longitudinal segments that are mounted with wheels to tracks on opposing sides of the opening. The door is configured to roll in an upwards-downwards motion to provide access to the opening in the structure. In the closed position the overhead door, specifically the bottom edge of the lowest segment will be superposed the ground. This surface is typically concrete or similar material. It is quite common for overhead doors to be operably coupled to an automatic opener or they can be manually operated to provide opening and closing thereof.

One issue with overhead doors results from exposure to inclimate weather. Most overhead doors are exposed to the external environment and as such the weather can create problem with proper operation of the door. By way of example but not limitation, freezing weather can often present an issue and inhibit proper overhead door operation. During freezing weather, ice can accumulate on the ground proximate the bottom edge of the overhead door from both inside and outside of the overhead door. As the ice accumulates proximate the bottom edge of the overhead door the ice will bond with the ground and the door creating a situation where now the overhead door is releasably secured to the ground. This results in an inability for an individual to open the overhead door without first removing the ice buildup that is releasably securing the door in a closed position.

Accordingly, there is a need for an apparatus, that is placed proximate the bottom edge of an overhead door in its closed position wherein the apparatus is configured to provide a temperature that is greater than that of its surroundings so as to inhibit ice formation.

### SUMMARY OF THE INVENTION

It is the object of the present invention to provide an overhead door apparatus that is configured to be placed proximate the bottom edge of an overhead door in its closed position wherein the present invention includes a body that is longitudinal in form.

Another object of the present invention is to provide an apparatus operable to be placed adjacent a bottom edge of an overhead door in its closed position wherein the body is formed to create a cavity extending between the first end and second end of the body.

A further object of the present invention is to provide an overhead door apparatus that is configured to be placed proximate the bottom edge of an overhead door in its closed position wherein body is manufactured from a single or multiple pieces of metal in the shape illustrated herein.

Still another object of the present invention is to provide an apparatus operable be placed adjacent a bottom edge of an overhead door in its closed position wherein the body extends generally the length of the bottom edge of the overhead door.

An additional object of the present invention is to provide an overhead door apparatus that is configured to be placed proximate the bottom edge of an overhead door in its closed position wherein the body includes an arcuate shaped top portion so as to inhibit interference with an overhead door in its closed position.

Yet a further object of the present invention is to provide an apparatus operable be placed adjacent a bottom edge of an overhead door in its closed position wherein the wing members are rounded in shape on the perimeter edge thereof and are configured to have fasteners journaled therethrough and into the ground so as to secure the body in position.

Another object of the present invention is to provide an overhead door apparatus that is configured to be placed proximate the bottom edge of an overhead door in its closed position wherein the bottom portion of the body has a sealing member secured thereto proximate a longitudinal edge of the body.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of an embodiment of the present invention; and

FIG. 2 is a front view of an embodiment of the present invention; and

FIG. 3 is an end view of an embodiment of the present invention; and

FIG. 4 is a top view of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an overhead door apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

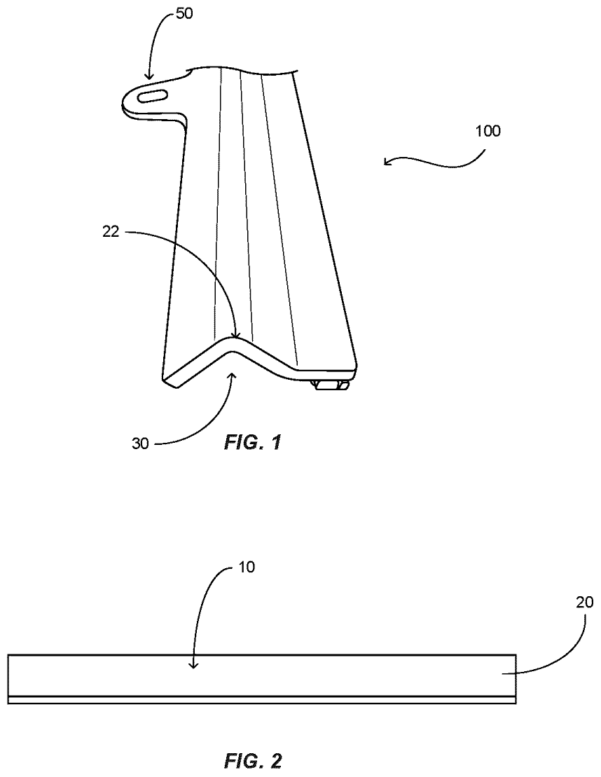

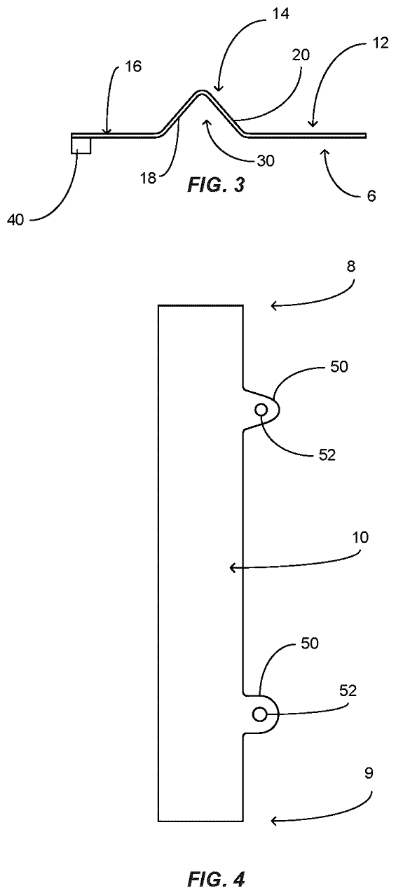

Referring in particular to the Figures submitted as a part hereof, the overhead door apparatus 100 includes a body 10 wherein the body 10 is elongated in manner having first end 8 and second end 9. The body 10 is manufactured from a heat conducting material such as but not limited to metal. The body 10 as illustrated herein in FIG. 1 and FIG. 3 includes a first segment 12, second segment 14 and third segment 16. The first segment 12 is planar in manner and contiguously formed with the second segment 14. The second segment 14 is comprised of a first portion 18 and second portion 20 wherein the first portion 18 is contiguous with the second portion 20. The second segment 14 includes rounded top edge 22 that is located at the transition between the first portion 18 and second portion 20. The top edge 22 is rounded in form so as to inhibit with interfering with an overhead door as the overhead door moves to its closed position. While the top edge 22 in a preferred embodiment is rounded in shape, it is contemplated within the scope of the present invention that the top edge 22 could be formed in alternate shapes. By way of example but not limitation, the top edge 22 could be formed in a flat top shape.

The orientation of the first portion 18 and second portion 20 creates a cavity 30 providing a space for a heating element ensuing the bottom surface 6 being placed on the ground. The bottom surface 6 of the body 10 along the third segment 16 has a sealing member 40 operably coupled thereto. Sealing member 40 is operably coupled to the bottom 6 employing suitable techniques such as but not limited to pressure sensitive adhesives. The sealing member 40 is manufactured from a durable material such as but not limited to rubber. The sealing member 40 functions to inhibit debris from egressing past the overhead door apparatus 100 and further provides a sufficient seal so as to block penetration of light and atmospheric air. It should be understood within the scope of the present invention that the sealing member 40 could be manufactured in alternate thicknesses. It should be further understood within the scope of the present invention that the sealing member 40 provides an improved seal over imperfections in concrete such as but not limited to chips and divots.

The body 10 has contiguously formed therewith wing members 50. The wing members 50 are square in shape and manufactured from a suitable material such as but not limited to metal. The wing members 50 are rounded in shape and include a central aperture 52. The central aperture 52 is operable to receive a fastener therethrough so as to secure the wing members 50, and as such the body 10, to the ground in the desired location. While two wing members 50 are illustrated herein, it is contemplated within the scope of the present invention that the overhead door apparatus 100 could have as few as one wing member 50 or more than two. Furthermore, while the wing members 50 are illustrated herein as being rounded in shape, it should be understood that the wing members 50 could be provided in alternate shapes and sizes.

It should be understood within the scope of the present invention that the body 10 could be provided in sections such as but not limited to four feet in length sections. Additionally, it should be understood within the scope of the present invention that the overhead door apparatus 100 could be placed across the entire span of the opening where the overhead door bottom edge is engaged or only a part thereof. Additionally, while mechanical fasteners are preferred, it should be understood within the scope of the present invention that the body 10 could be chemically adhered in place. Furthermore, it is additionally contemplated within the scope of the present invention that the body 10 could be buried or cast into the concrete in the desired position as opposed to be superposed thereto.

The overhead door apparatus 100 includes a heating element (not particularly illustrated herein). The heating element is linear in form and is configured to be disposed within the body 10. The heating element is a conventional electrical heating element that is electrically coupled to a suitable power supply (not particularly illustrated herein). The heating element is configured to extend substantially between the first end 8 and second end 9 of the body 10. While an electric heating element is the preferred embodiment for the heating element, it is contemplated within the scope of the present invention that the heating element could be provided in alternate embodiments and achieve the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An overhead door apparatus configured to be placed proximate a bottom edge of an overhead door in its closed position and provide sealing of the bottom edge wherein the overhead door apparatus comprises:
a body, said body having a first end and a second end, said body having a first segment, a second segment and a third segment, said first segment, said second segment and said third segment being contiguously formed, said second segment being intermediate said first segment and said third segment, said second segment having a first portion and a second portion, said first portion and said second portion being angular in orientation with respect to each other, said second segment having a rounded top edge at a transition point of said first portion and said second portion of said second segment, said first segment having an outer longitudinal edge distal to said second segment, said first segment of said body being planar in manner, said third segment having an outer longitudinal edge distal to said second segment, said second segment configured to create a cavity subsequent said body being superposed a ground;
at least two wing members, said at least two wing members being contiguously formed with said body along said outer longitudinal edge of said first segment, said at least two wing members having a central aperture configured to have a fastener journaled therethrough; and
a sealing member, said sealing member being secured to a bottom surface of said third segment of said body, said sealing member being proximate said outer longitudinal edge of said third segment extending intermediate said first end and said second end of said body.

2. The overhead door apparatus configured to be placed proximate the bottom edge of the overhead door as recited in claim 1, wherein said sealing member is manufactured from rubber.

3. The overhead door apparatus configured to be placed proximate the bottom edge of the overhead door as recited in claim 2, wherein said body is manufactured from a contiguous piece of metal.

4. The overhead door apparatus configured to be placed proximate the bottom edge of the overhead door as recited in claim 3, wherein said at least two wing members having a rounded outer perimeter edge.

5. The overhead door apparatus configured to be placed proximate the bottom edge of the overhead door as recited in claim 4, wherein said third segment is planar in manner extending outward from said second segment.

6. The overhead door apparatus configured to be placed proximate the bottom edge of the overhead door as recited in claim 5, and further including a heating element, said heating element being configured to be disposed in
said body, said heating element configured to provide a temperature for said body that is greater than that of environmental surroundings of the body.
